(19) United States
(12) Patent Application Publication
(10) Pub. No.: US 2024/0079889 A1
(43) Pub. Date: Mar. 7, 2024

(54) CHARGING BASE SYSTEM

(71) Applicant: ACCO BRANDS CORPORATION, Lake Zurich, IL (US)

(72) Inventors: Yannik Wiggemans, Lake Zurich, IL (US); Jon Gretz, Lake Zurich, IL (US); Frank Van Brussel, Lake Zurich, IL (US)

(21) Appl. No.: 18/157,131

(22) Filed: Jan. 20, 2023

Related U.S. Application Data
(60) Provisional application No. 63/374,679, filed on Sep. 6, 2022.

(51) Int. Cl. H02J 7/00; A63F 13/98

(52) U.S. Cl. CPC H02J 7/0045; A63F 13/98; H02J 7/0013

(57) ABSTRACT

A video game controller charging base assembly includes an electrical connector configured to connect to a power source, a charging stand that includes a charging connection in communication with the electrical connector to receive electrical power therefrom, and a controller dongle with a first connection configured to electrically attach to a video game controller and a second connection configured to electrically connect to the charging connection. At least one of the charging connection or the second connection can be configured to allow movement of the second connection relative to the charging connection along at least one axis while maintaining electrical connection between the charging connection and the second connection of the controller dongle.

### RELATED APPLICATION

This application claims priority to U.S. Provisional Patent Application No. 63/374,679, filed on Sep. 6, 2022, and titled “CONTROLLER CHARGING BASE,” the entirety of which is incorporated herein by reference.

### FIELD

The present disclosure relates to a controller charging base system configured to operate with a variety of video game controllers.

### BACKGROUND

Wireless video game controllers that are not directly connected to a power source rely on an internal power source for power during operation. The internal power source typically includes rechargeable batteries that store energy for use by the video game controller. The video game controller batteries may be recharged via a charge port (e.g., USB) in the game controller. Conventional recharging of video game controllers consists of simple plugging in of a power cable (e.g., USB) to the video game controller's charge port while the controller rests on a surface. This solution, however, is not elegant as it tends to produce tangled cables, particularly where multiple controllers need charged. There have been efforts in the art to provide charging bases that would address these issues. However, because form factors and locations of charge ports vary widely amongst video game controller models, these efforts have produced disappointing results, requiring a specifically designed charging base for each model of video game controller.

### SUMMARY

Conventionally, the process of recharging a video game controller's internal chargeable battery involves attaching the video game controller to a charging device specifically shaped for charging that specific model of video game controller. However, because the charging device is shaped for a particular model video game controller, different charging devices need to be used, a specific device for each different model video game controller that may have different shapes and/or connections from other models. This means that a user must purchase different charging devices, potentially as many charging devices as video game controllers.

The present application provides a video game controller charger port dongle and a charging base. With the dongle installed to the video game controller, the controller is movable along at least one axis while maintaining an electrical connection to the charging base. This feature allows the charging base system to accommodate different shapes and sizes of video game controllers. The dongle and charging base described herein may include a structure that permits adjustment of the electrical connection point along a first axis and/or a second axis perpendicular to each other while maintaining the electrical connection. Thus, the user may move/adjust the electrical connection point to different positions with respect to the charging base to accommodate different video game controllers, while maintaining the electrical connection to charge the video game controller.

According to an aspect of the disclosure, a video game controller charging base assembly comprises an electrical connector configured to connect to a power source; a charging stand that includes a charging connection in communication with the electrical connector to receive electrical power therefrom; and a controller dongle with a first connection configured to electrically attach to a video game controller and a second connection configured to electrically connect to the charging connection, wherein at least one of the charging connection or the second connection is configured to allow movement of the second connection relative to the charging connection along at least one axis while maintaining electrical connection between the charging connection and the second connection of the controller dongle.

According to an embodiment of any paragraph(s) of this summary, the charging connection includes a vertically elongated contact and the second connection includes a protruding single point contact that corresponds to the vertically elongated contact such that, when the controller dongle is connected to the video game controller, the video game controller is movable vertically while maintaining the electrical connection.

According to an embodiment of any paragraph(s) of this summary, the vertically elongated contact is in a plurality of vertically elongated contacts in the charging connection, wherein the protruding single point contact is in a plurality of protruding single point contacts.

According to an embodiment of any paragraph(s) of this summary, the plurality of vertically elongated contacts each have a corresponding protruding single point contact in the plurality of protruding single point contacts.

According to an embodiment of any paragraph(s) of this summary, the at least one of the charging connection or the second connection is further configured to allow movement of the second connection relative to the charging connection along a second axis while maintaining the electrical connection.

According to an embodiment of any paragraph(s) of this summary, the charging connection includes a spring-loaded connection and the second connection includes a magnetic portion corresponding to the spring loaded connection such that the spring loaded connection is movable horizontally to engage the second connection.

According to an embodiment of any paragraph(s) of this summary, the spring-loaded connection is movable along a spectrum between an initial retracted position and a second extended position, wherein the spring is biased toward the initial retracted position.

According to an embodiment of any paragraph(s) of this summary, the second connection is a spring-loaded pin configured to removably retract into a body of the controller dongle.

According to an embodiment of any paragraph(s) of this summary, further comprises a base body including a charging cradle shaped to receive a portion of the video game controller when the controller dongle is electrically attached to the video game controller and electrically connected to the charging connection.

According to an embodiment of any paragraph(s) of this summary, further comprises a base body that includes a charging tower that includes the charging stand on a first portion of the charging tower, wherein the charging tower further includes a charging station on a second portion of the charging tower, wherein the charging station is configured to electrically connect a second video game controller to the electrical connector.

According to another aspect of the disclosure, a video game controller charging base assembly comprises: an electrical connector configured to connect to a power source; a charging base body in communication with the electrical connector to receive electrical power therefrom, wherein the charging base body further includes a charging cradle shaped to receive and removably retain a first video game controller, wherein the charging base body further includes a charging tower adjacent the charging cradle; a charging stand on a first portion of the charging tower, wherein the charging stand includes a charging connection in communication with the electrical connector, wherein the charging connection is configured to allow movement of a controller dongle electrically attached to the first video game controller relative to the charging connection in at least two axes while maintaining electrical connection between the charging connection and the first video game controller; and a charging station on a second portion of the charging tower, wherein the charging station is configured to electrically connect a second video game controller to the electrical connector.

According to an embodiment of any paragraph(s) of this summary, the charging connection includes vertically elongated contacts shaped to permit vertical movement of the controller dongle while maintaining the electrical connection.

According to an embodiment of any paragraph(s) of this summary, the charging stand is spring-loaded in the charging tower and configured to move horizontally relative to the charging tower along a spectrum between an initial retracted position and a second extended position to engage the controller dongle.

According to an embodiment of any paragraph(s) of this summary, further including a second charging station on a third portion of the charging tower, wherein the second charging station is configured to electrically connect a third video game controller to the electrical connector.

According to an embodiment of any paragraph(s) of this summary, the electrical connector includes a universal serial bus (USB) connector.

According to an embodiment of any paragraph(s) of this summary, the charging base body further includes a roughened surface configured to limit movement of the charging base body.

According to an embodiment of any paragraph(s) of this summary, the charging base body further includes an indentation formed to removably receive and retain a portion of the controller dongle.

According to yet another aspect of the disclosure, a controller dongle for connecting a video game controller to a controller base assembly comprises: a first connection configured to electrically attach to the video game controller; and a second connection configured to electrically connect to a charging connection of a controller base assembly, wherein the second connection is further configured to allow movement of the second connection relative to the charging connection along at least two axes while maintaining the electrical connection between the charging connection and the second connection.

According to an embodiment of any paragraph(s) of this summary, the second connection includes a single point contact configured to electrically connect to a corresponding vertically elongated contact in the charging connect such that the second connection is movable vertically while maintaining the electrical connection.

According to an embodiment of any paragraph(s) of this summary, the second connection includes a magnetic portion that corresponds to a spring-loaded connection of the charging connection such that spring-loaded connection is movable horizontally while maintaining the electrical connection.

To the accomplishment of the foregoing and related ends, the disclosure comprises the features hereinafter fully described and particularly pointed out in the claims. The following description and the annexed drawings set forth in detail certain illustrative embodiments of the disclosure. These embodiments are indicative, however, of but a few of the various ways in which the principles of the disclosure may be employed. Other objects, advantages and novel features of the disclosure will become apparent from the following detailed description when considered in conjunction with the drawings.

### BRIEF DESCRIPTION OF DRAWINGS

The annexed drawings, which are not necessarily to scale, show various aspects of the disclosure.

FIG. 1 is a view of a controller charging base assembly according to an embodiment of the disclosure.

FIG. 2 is a view of the charging stand and the controller dongle of FIG. 1 in isolation.

FIG. 3 is another view of the controller dongle of FIG. 1 in isolation.

FIGS. 4-6 illustrate a process of moving the controller dongle of FIG. 1 along a second axis while maintaining an electrical connection according to an embodiment of the disclosure.

FIG. 7 is another view of the controller charging base assembly of FIG. 1

FIG. 8 illustrates the controller dongle attached to a video game controller according to an embodiment of the disclosure.

FIG. 9 illustrates a view of controller charging base assembly of FIG. 1 with a plurality of video game controllers attached thereto.

### DETAILED DESCRIPTION

Aspects of the present application that pertain to a multi-use controller charging base assembly are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

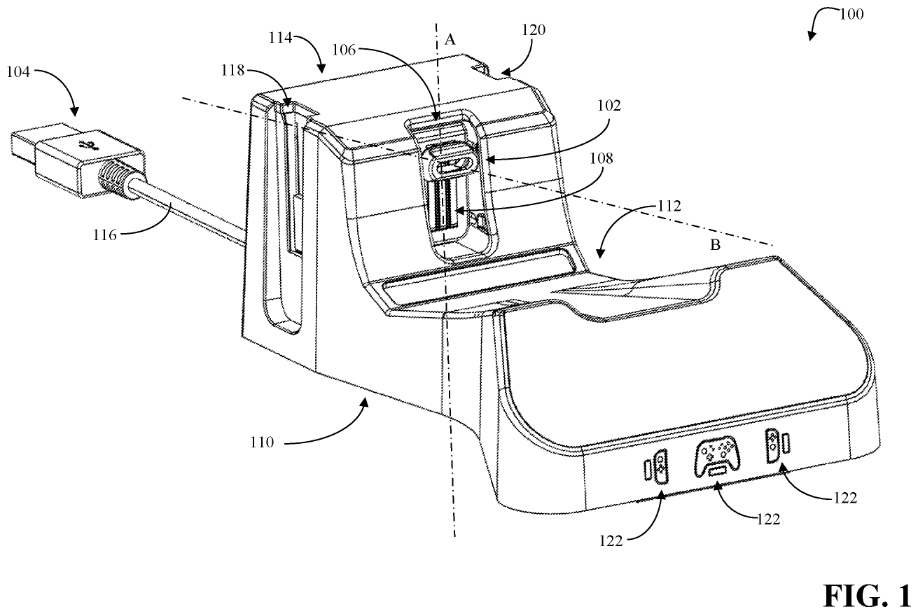

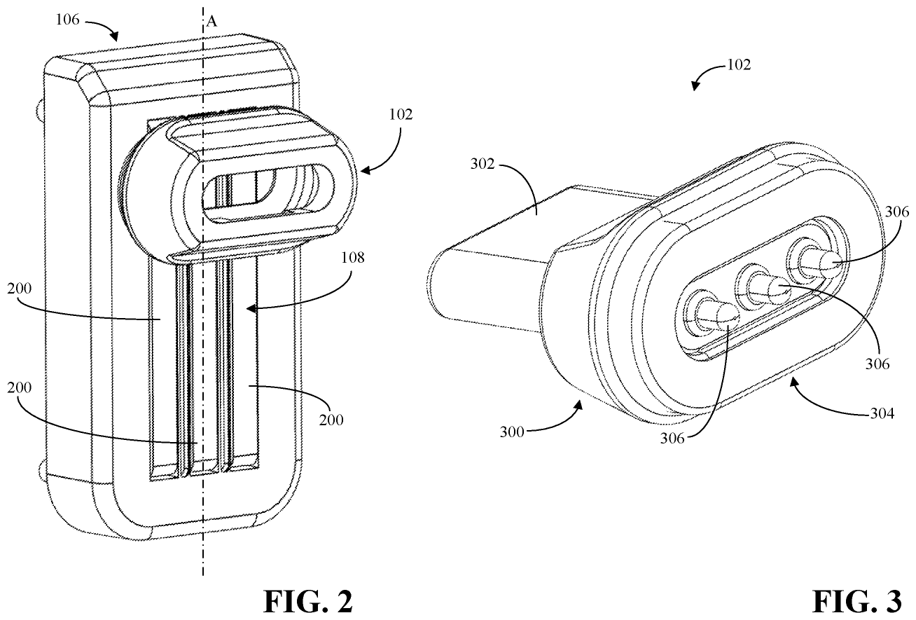

FIG. 1 illustrates a controller charging base assembly 100 that allows a user to use the same charging base assembly to charge different controllers by using an adapter that connects the controller to the charging base. To accommodate controllers of different shapes and sizes, the adapter and/or the charging base can be configured to allow movement of the adapter relative to the charging base while maintaining an electrical connection therebetween. In the following embodiments, the controller comprises a video game controller, but any suitable controllers may be used. Any suitable adapter may be used, and different adapters may be used for different video game controllers. In the embodiments illustrated herein, the adapter comprises a controller dongle 102 configured for use with multiple video game controllers. Portions of the controller dongle 102 are removed in FIGS. 1 and 2 for clarity but can be seen for instance in FIG. 3.

The illustrated controller charging base assembly 100 includes an electrical connector 104 configured to connect to a power source (not pictured) and a charging stand 106 that includes a charging connection 108 in communication with the electrical connector 104 to receive electrical power therefrom. The controller dongle 102 can be configured to electrically connect to the charging connection 108 to provide power to an attached video game controller. To accommodate video game controllers of different sizes, the controller dongle 102 and/or the charging connection 108 can be configured to allow movement of the controller dongle 102 relative to the charging connection 108 along one or more axes while maintaining the electrical connection between the controller dongle 102 and the charging connection 108, as will be described in detail below. The controller dongle 102 can be configured to move along any suitable number of axes (e.g., one, two, three, etc.) that can be arranged in any suitable configuration. For instance, in the illustrated embodiment, the controller dongle 102 can move along a first axis A as well as along a second axis B that are arranged perpendicular to each other.

The electrical connector 104 can take any suitable configuration for connecting to the power source and different electrical connectors 104 can be used depending on the configuration of the charging connection 108, the controller dongle 102, the connected video game controllers, and/or the like. For instance, the electrical connector 104 can be a power plug with any suitable number of prongs, such as a two-prong plug, a three-prong plug, a four-prong plug, and/or the like. In the illustrated embodiment, the electrical connector 104 comprises a universal serial bus (USB) connector/plug configured attach to a corresponding receptacle.

The controller charging base assembly 100 can further include a base body 110 that removably holds portion(s) of the video game controller while charging the video game controller. The base body 110 can take any suitable shape and/or configuration for holding the video game controller. In the illustrated embodiment, the base body 110 includes a charging cradle 112 shaped to hold the video game controller and a charging tower 114 that can include the charging stand 106 and is adjacent the charging cradle 112. The charging stand 106 can be arranged on the charging tower 114 such that the controller dongle 102 maintains the electrical connection with the charging connection 108 while the video game controller rests in the charging cradle 112.

The base body 110 can further include components that connect the charging connection 108 and the electrical connector 104, such as wires, cables, and/or the like. In the illustrated embodiment, the electrical connector 104 is connected to the base body 110 via a cable 116 to space the base body 110 from the power source.

The controller charging base assembly 100 can be further configured to simultaneously charge multiple video game controllers. More particularly, the controller charging base assembly 100 can include a plurality of charging ports to charge multiple video game controllers and the plurality of charging ports may have similar configurations and/or can vary. For instance, the controller charging base assembly 100 can include a first charging port with a first configuration (e.g., the charging stand 106) and a second charging port with a second different configuration.

In the illustrated embodiment, the controller charging base assembly 100 includes different charging ports that have different configurations. Namely, the controller charging base assembly 100 includes the charging stand 106 and the corresponding control dongle 102 (described above), a first charging station 118, and a second charging station 120 that are all arranged on the charging tower 114. However, the first charging station 118 and/or the second charging station 120 can be located at any suitable portion of the base body 110. The illustrated charging tower 114 has a generally rectangular cross-section with the charging stand 106 arranged to extend along a length of a first side of the charging tower 114, the first charging station 118 arranged to extend along a length of a second side of the charging tower 114, and the second charging station 120 arranged to extend along a length of a third side opposite the second side.

In contrast to the charging stand 106 which relies on the controller dongle 102 to electrically connect to a video game controller, the first charging station 118 and the second charging station 120 are configured for direct electrical connection to a video game controller. The first charging station 118 and/or the second charging station 120 can be further configured to only connect to a particular video game controller.

The controller charging base assembly 100 can further include one or more indicators designed to inform a user of a charging state of an attached video game controller. For instance, the controller charging base assembly 100 can include one or more lights that change color to indicate a charging state of the attached video game controller, such as a first color to indicate a charging status where the attached video game controller is charging and a second color to indicate a charged status where the attached video game controller is fully charged. In the illustrated embodiment, the base body 110 includes three separate light indicators 122 to indicate a charging state of video game controllers attached to the charging connection 108, the first charging station 118, and/or the second charging station 120.

Turning now to FIG. 2, illustrated is the charging stand 106 in isolation with the controller dongle 102 connected thereto. As briefly mentioned above, the charging connection 108 and/or the controller dongle 102 can be configured to allow movement of the controller dongle 102 longitudinally along the first axis A while maintaining the electrical connection between the charging connection 108 and the controller dongle 102. Any suitable configuration can be used that permits the vertical movement of the controller dongle 102. The charging connection 108 can cover an entire side of the charging stand 106 and/or portion(s) thereof. Moreover, the charging connection 108 can take any suitable shape and/or configuration and may be a single piece of connecting material and/or a plurality of separate pieces. In the illustrated embodiment, the charging connection 108 is a strip 200 of conductive material that extends along a portion of the charging strip 106. More particularly, the charging connection 108 is three individual strips 200. Any suitable conductive material can be used for the charging connection 108, such as copper, aluminum, and/or the like.

The controller dongle 102 can be configured to engage all three strips of the charging connection 108 simultaneously and/or only a portion of the charging connection 108. In the embodiments illustrated herein, the controller dongle 102 is configured to engage all three strips of the charging connection 108 simultaneously. As can be seen more clearly in FIG. 3, the controller dongle 102 includes a body 300 that includes a first connector 302 at a first end and a second connector 304 at a second end. The first connector 302 can be configured for electrical connection to a video game controller and the second connector 304 can be configured for electrical connection to the charging connection 108. The first connector 302 and the second connector 304 can be similar and/or can vary.

In the illustrated embodiment, the first connector 302 is a USB-C plug connector configured to electrically connect to a corresponding socket in a video game controller's power port. The second connector 304 can include structure to individually engage each of the strips of the charging connection 108 and/or the same structure can engage multiple strips. In the illustrated embodiment, the second connector 304 is three charging contacts 306 each shaped to engage one of the strips of the charging connection 108. In one embodiment, the charging contacts 306 may rigidly extend outward. In another embodiment, the charging contacts 306 can be movable into and out of body 300, such as spring-loaded and biased outward. Thus, the charging contacts 306 can move up and down the first axis A along the strips while maintaining the electrical connection between the charging connection 108 and the controller dongle 102.

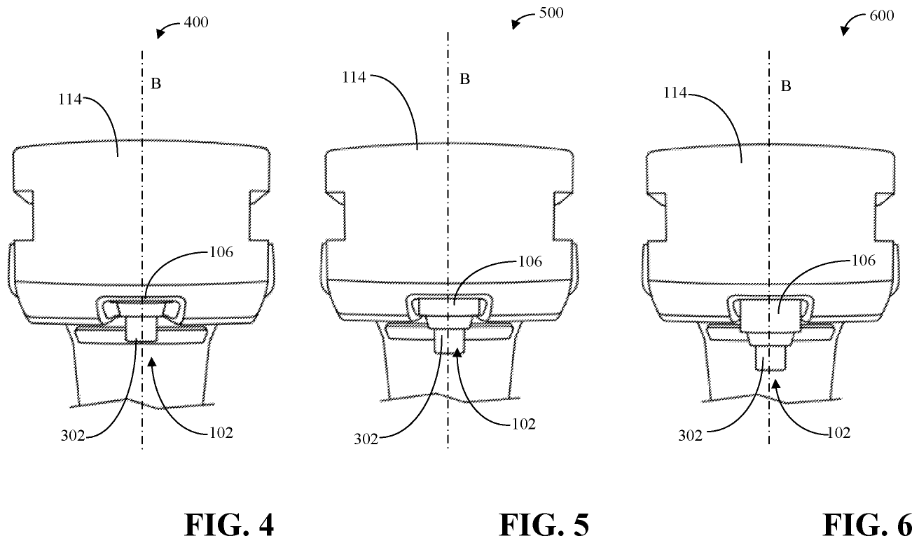

As briefly mentioned above, in addition to moving along the first axis A while maintaining the electrical connection, the controller dongle 102 and/or the charging connection 108 can be configured to permit movement of the controller dongle 102 along the second axis B while maintaining the electrical connection. Turning now to FIGS. 4-6, illustrated is an embodiment of the controller dongle 102 moving in a spectrum between a retracted position 400 (FIG. 4) and a fully extended position 600 (FIG. 6). In the embodiments illustrated herein, the charging stand 106 can be configured to move relative to the charging tower 114. For instance, the charging stand 106 can travel into and out of a corresponding aperture in a surface of the charging tower 114. The charging stand 106 can be further configured to be biased toward a specific position to resiliently return to that position in a neutral state. For example, the controller charging base assembly 100 can include a spring that biases the charging stand 106 toward the retracted position 400. In addition to the fully extended position 600, the charging stand 106 can be moved to an intermediate position 500 (FIG. 5) which is between the retracted position 400 and the fully extended position 600.

Any suitable structure(s) can be used to maintain the electrical connection between the controller dongle 102 and the charging connection 108 as the controller dongle 102 moves along the second axis B. For example, the controller dongle 102 may include a magnet or magnetic material and the charging stand 106 may include a corresponding magnet or magnetic material, and a magnetic force between the magnets/magnetic materials keeps the controller dongle 102 and the charging connection 108 connected. In another example, the controller dongle 102 and/or the charging stand 106 may include an interlocking snapping structure.

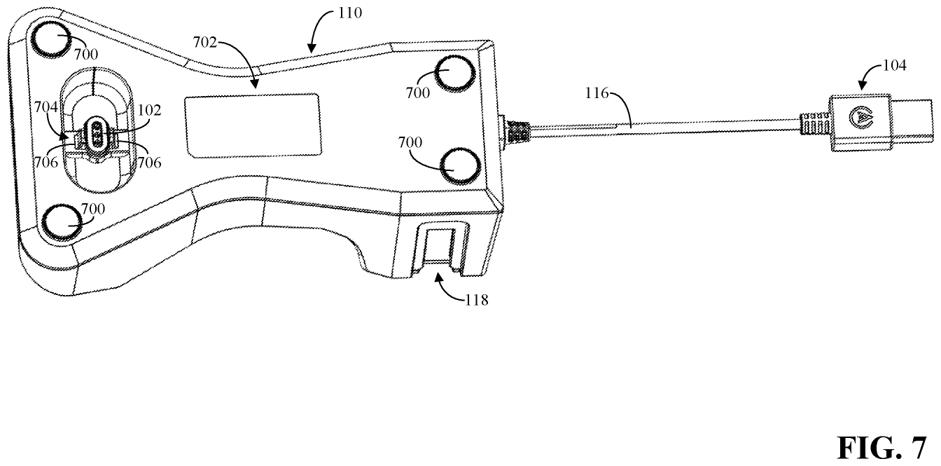

The base body 110 can further include structure to limit movement of the base body 110 to prevent unintentional movement of the base body 110 when attaching and/or detaching a video game controller. For instance, in the embodiment illustrated in FIG. 7, the base body 110 can include one or more roughened surfaces 700 on a bottom 702 of the base body 110. The roughened surface 700 can include a separate felt attached to the bottom 702, a ridged surface on the bottom 702, and/or the like. The bottom 702 can include any suitable number of roughened surfaces 700 and in the illustrated embodiment, the bottom 702 includes four roughened surfaces 700. In one embodiment, the surfaces 700 may correspond to rubber (or similar material) pads to prevent sliding of the base assembly 100.

The controller charging base assembly 100 may further include holding structure to removably hold the controller dongle 102 while not attached to a video game controller or the charging stand 106. The holding structure can be used to keep track of the controller dongle 102 when not in use. In the embodiment illustrated in FIG. 7, the bottom 702 of the base body 110 includes a notch 704 that can removably hold a portion of the controller dongle 102. The bottom 702 may further include flexible arms 706 adjacent the notch 704 to both hold the controller dongle 102 within the notch 704 as desired and resiliently flex outward while inserting the controller dongle 102 into the notch 704 and/or removing the controller dongle 102 from the notch 704.

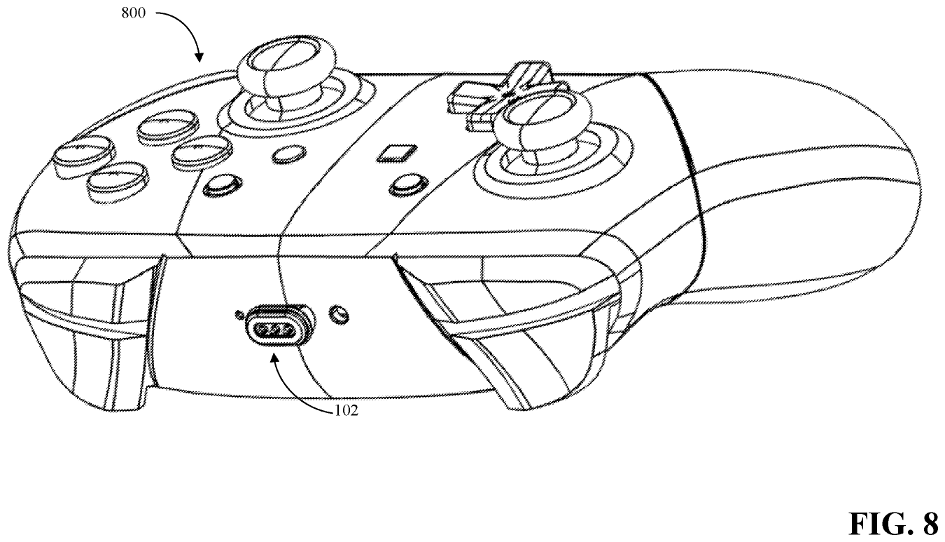

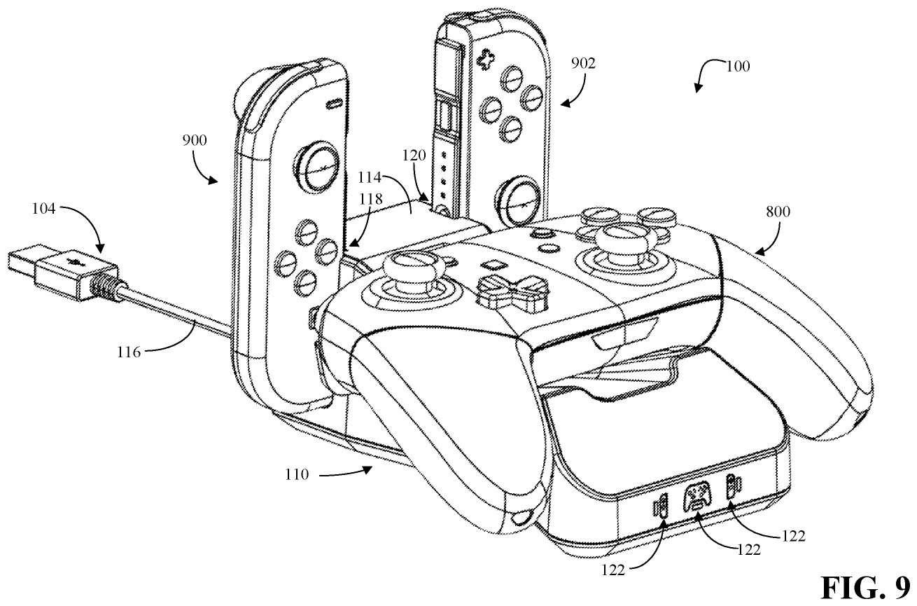

The controller charging base assembly 100 can be configured for use with any suitable video game controller. Moreover, as noted above, different charging ports may be configured for different controllers and the controller dongle 102 can be used to connect a variety of different shaped and sized video game controllers to the same charging connection 108. Illustrated in FIG. 8 is the controller dongle 102 electrically connected to a video game controller 800. FIG. 9 illustrates an exemplary embodiment of the video game controller 800 connected to the base body 110 as well as two different vertical controllers connected to the base body 110. More particularly, a first controller 900 includes a charging contact on a first side of the first controller 900 shaped and arranged to engage the first charging station 118. The illustrated second controller 902 includes a charging contact on a second side of the second controller 902 shaped and arranged to engage the second charging station 120. The first charging station 118 and the second charging station 120 can be shaped to electrically connect only to the first controller 900 and the second controller 902, respectively. For example, the first charging station 118 and the second charging station 120 may be shrouded as to shield electrical contacts of the first charging station 118 and the second charging station 120 from unintentional contact or from other controllers not intended to be charged by the first charging station 118 and the second charging station 120.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A video game controller charging base assembly comprising:
an electrical connector configured to connect to a power source;
a charging stand that includes a charging connection in communication with the electrical connector to receive electrical power therefrom; and
a controller dongle with a first connection configured to electrically attach to a video game controller and a second connection configured to electrically connect to the charging connection,
wherein at least one of the charging connection or the second connection is configured to allow movement of the second connection relative to the charging connection along at least one axis while maintaining electrical connection between the charging connection and the second connection of the controller dongle.

2. The charging base assembly of claim 1, wherein the charging connection includes a vertically elongated contact and the second connection includes a protruding single point contact that corresponds to the vertically elongated contact such that, when the controller dongle is connected to the video game controller, the video game controller is movable vertically while maintaining the electrical connection.

3. The charging base assembly of claim 2, wherein the vertically elongated contact is in a plurality of vertically elongated contacts in the charging connection, wherein the protruding single point contact is in a plurality of protruding single point contacts.

4. The charging base assembly of claim 3, wherein the plurality of vertically elongated contacts each have a corresponding protruding single point contact in the plurality of protruding single point contacts.

5. The charging base assembly of claim 1, wherein the at least one of the charging connection or the second connection is further configured to allow movement of the second connection relative to the charging connection along a second axis while maintaining the electrical connection.

6. The charging base assembly of claim 1, wherein the charging connection includes a spring-loaded connection and the second connection includes a magnetic portion corresponding to the spring loaded connection such that the spring loaded connection is movable horizontally to engage the second connection.

7. The charging base assembly of claim 6, wherein the spring-loaded connection is movable along a spectrum between an initial retracted position and a second extended position, wherein the spring is biased toward the initial retracted position.

8. The charging base assembly of claim 1, wherein the second connection is a spring-loaded pin configured to removably retract into a body of the controller dongle.

9. The charging base assembly of claim 1, further comprising a base body including a charging cradle shaped to receive a portion of the video game controller when the controller dongle is electrically attached to the video game controller and electrically connected to the charging connection.

10. The charging base assembly of claim 1, further comprising a base body that includes a charging tower that includes the charging stand on a first portion of the charging tower, wherein the charging tower further includes a charging station on a second portion of the charging tower, wherein the charging station is configured to electrically connect a second video game controller to the electrical connector.

11. A video game controller charging base assembly comprising:
an electrical connector configured to connect to a power source;
a charging base body in communication with the electrical connector to receive electrical power therefrom, wherein the charging base body further includes a charging cradle shaped to receive and removably retain a first video game controller, wherein the charging base body further includes a charging tower adjacent the charging cradle;
a charging stand on a first portion of the charging tower, wherein the charging stand includes a charging connection in communication with the electrical connector, wherein the charging connection is configured to allow movement of a controller dongle electrically attached to the first video game controller relative to the charging connection in at least two axes while maintaining electrical connection between the charging connection and the first video game controller; and
a charging station on a second portion of the charging tower, wherein the charging station is configured to electrically connect a second video game controller to the electrical connector.

12. The charging base assembly of claim 11, wherein the charging connection includes vertically elongated contacts shaped to permit vertical movement of the controller dongle while maintaining the electrical connection.

13. The charging base assembly of claim 11, wherein the charging stand is spring-loaded in the charging tower and configured to move horizontally relative to the charging tower along a spectrum between an initial retracted position and a second extended position to engage the controller dongle.

14. The charging base assembly of claim 11, further including a second charging station on a third portion of the charging tower, wherein the second charging station is configured to electrically connect a third video game controller to the electrical connector.

15. The charging base assembly of claim 11, wherein the electrical connector includes a universal serial bus (USB) connector.

16. The charging base assembly of claim 11, wherein the charging base body further includes a roughened surface configured to limit movement of the charging base body.

17. The charging base assembly of claim 11, wherein the charging base body further includes an indentation formed to removably receive and retain a portion of the controller dongle.

18. A controller dongle for connecting a video game controller to a controller base assembly comprising:
a first connection configured to electrically attach to the video game controller; and
a second connection configured to electrically connect to a charging connection of a controller base assembly, wherein the second connection is further configured to allow movement of the second connection relative to the charging connection along at least two axes while maintaining the electrical connection between the charging connection and the second connection.

19. The controller dongle of claim 18, wherein the second connection includes a single point contact configured to electrically connect to a corresponding vertically elongated contact in the charging connect such that the second connection is movable vertically while maintaining the electrical connection.

20. The controller dongle of claim 18, wherein the second connection includes a magnetic portion that corresponds to a spring-loaded connection of the charging connection such that spring-loaded connection is movable horizontally while maintaining the electrical connection.
